(19) United States
(12) Patent Application Publication
(10) Pub. No.: US 2021/0199909 A1
(43) Pub. Date: Jul. 1, 2021

(54) OPTICAL FIBRE CABLE ELEMENT AND OPTICAL FIBER CABLE CONSTRUCTION COMPRISING THE SAME

(71) Applicant: DSM IP Assets B.V., Heerlen (NL)

(72) Inventors: Pim Gerard Anton JANSSEN, Echt (NL); Armand Alphons Marie Agnes DUIJSENS, Echt (NL)

(21) Appl. No.: 16/754,895

(22) PCT Filed: Oct. 18, 2018
(86) PCT No.: PCT/EP2018/078621

§ 371 Date: Apr. 9, 2020

(30) Foreign Application Priority Data
Oct. 20, 2017 (EP) 17197489.2

(51) Int. Cl. G02B 6/44; C08G 69/26

(52) U.S. Cl. CPC G02B 6/4486; C08G 69/265

(57) ABSTRACT

The invention relates to an optical fiber cable element comprising a buffer tube and a number of optical fibers enveloped by the buffer tube, wherein the buffer tube comprises a semi-crystalline semi-aromatic polyamide comprising repeat units derived from monomers essentially consisting of dicarboxylic acid and diamine, comprising at least 55 mole % aromatic dicarboxylic acid, relative to the total molar amount of dicarboxylic acid, and having a glass transition temperature (Tg) of at least 100° C. The invention further relates to a process for producing the optical fiber cable element, and to an optical fiber cable construction, comprising a jacket and one or more optical fiber cable elements.

The present invention relates to an optical fiber cable element and to an optical fiber cable construction comprising an optical fiber cable element.

Optical fiber cable elements generally comprise a tube and one or more optical fibers enveloped by the tube, i.e. the one or more optical fibers are inside the hollow space of the tube. Such a tube is generally known as buffer tube. An optical fiber cable construction generally comprises a jacket and several optical fiber cable elements enveloped by the jacket. Depending on the aimed functionality and capacity of the optical fiber cable construction, the optical fiber cable construction may comprise one or more optical fiber cable elements, typically from one up to and including 12, whereas the number of optical fibers within each of the optical fiber cable elements also typically vary from 1 up to and including 12. The buffer tube can be a loose tube, a tight tube or a semi-tight (or semi-loose or loose-tight) tube. In a loose tube, the optical fibers can move within the space confined by the tube. In a tight buffer tube, the optical fibers cannot move at all. In a semi-tight tube, the optical fibers have limited movement possibilities.

Materials often used for the components in an optical fiber cable construction are glass fibers or transparent plastic fibers for the optical fibers, and a thermoplastic polymer such as polycarbonate (PC) or polybutylene terephthalate (PBT) for the buffer tube. The jacket can for example be made of a thermoplastic such as HDPE, TPU, PVC or polyamide-12. It has the function to protect against external environmental influences and generally does not comprise reinforcing components. The optical fiber cable element may further comprise a coating on the optical fibers and optionally a thixotropic gel inside the buffer tube.

Further components optionally comprised by the optical fiber cable construction include one or more strength members, filling tubes, flooding gel between buffer tubes, a rip cord, water blocking systems, inner sheets and one or more tape constructions strapped around the one or more optical fiber cable elements, and optionally the strength members and filling tubes, inside the jacket. The flooding gel between buffer tubes and filling tubes shall protect the cable core from water penetration. The strength members can be made from, for example, aramid fiber, high molecular weight polyethylene fiber and other high strength fiber or fiber reinforced plastic, metal webs, metal wires and tapes, whereas for the filling tubes hollow tubes made of, for example, polyethylene or polypropylene can be used.

A general goal with optical fiber cable constructions is to increase transmission capacity within a given available space or to retain a high capacity while reducing space requirements, and at the same time retain performance integrity under various conditions. In other words, dimensions should diminish, with retention of functionality, while signal loss or signal damping as a result to mechanical stresses and environmental stresses shall be limited. Smaller dimensions not only require less space but also allow for lower installation costs and duct rental cost, in particular in highly populated domestic surroundings.

A problem with current optical fiber cable constructions, is that reduction in dimension with buffer tubes made of PBT or PC is critical and leads to signal loss under various conditions, for example under conditions wherein temperature variations occur or wherein in the optical fiber cable construction is exposed to cleaning solvents used in the installation to remove the thixotropic gel from the optical fiber elements after cutting. Cleaning solvents often used for optical fiber cables comprise high concentrations of isopropanol, acetone or ethanol.

The aim of the invention is to provide an optical fiber cable construction, and an optical fiber cable element that can be used therein, that does not show the above problems, or in less extent. At the same time, good installability shall be maintained, in other words allowing for good stripping, cleaning, and splicing.

This aim has been achieved with the optical fiber cable element according to the invention, and with the optical fiber cable construction comprising the same. The optical fiber cable element according to the invention comprises a tube and one or more optical fibers inside the hollow space of the tube, wherein the tube is made of a semi-crystalline semi-aromatic polyamide or of a composition comprising the semi-crystalline semi-aromatic polyamide and at least one other component, and wherein the semi-crystalline semi-aromatic polyamide
has a glass transition temperature (Tg) of at least 100° C., and
consists of repeat units derived from diamine, dicarboxylic acid and 0-5 mole % other polyamide forming monomers, relative to the total molar amount of diamine, dicarboxylic acid and other polyamide forming monomers
and at least 55 mole % of the dicarboxylic acid is aromatic dicarboxylic acid.

Herein the glass transition temperature (Tg) is measured by the method according to ISO-11357-1/2, 2011, with a heating and cooling rate of 20° C./min.

The effect of the optical fiber cable element according to the invention, is that the tube, further herein also referred as buffer tube, has a better combination of retention of signal transmittance, mechanical stress resistance, environmental stress resistance and solvent resistance compared to PBT and PC, and alternatively can be designed with smaller dimensions, i.e. with a smaller wall thickness, and eventually with a smaller outer diameter and a smaller inner diameter while retaining good mechanical stress resistance, good environmental stress resistance and good solvent resistance. This effect is illustrated with the examples shown further below.

With a semi-crystalline polyamide is herein understood that the polyamide is a thermoplastic polymer having amorphous domains characterized by a glass transition temperature (Tg), and crystalline domains characterized by a melting temperature (Tm).

More particular, the semi-crystalline semi-aromatic polyamide used in the tube of the optical fiber cable element according to the invention has a glass transition temperature (Tg) of at least 100° C., preferably at least 110° C., more preferably at least 120° C. Herein the glass transition temperature (Tg) measured by the differential scanning calorimetry (DSC) method according to ISO-11357-112, 2011, on pre-dried samples in an N₂ atmosphere with a heating and cooling rate of 20° C./min. Herein Tg has been calculated from the value at the peak of the first derivative (in respect of temperature) of the parent thermal curve corresponding with the inflection point of the parent thermal curve in the second heating cycle.

Also preferably, the semi-crystalline semi-aromatic polyamide has a melting temperature (Tm) of at least 240° C., more preferably at least 270° C. Herein, the melting temperature is measured by the DSC method according to ISO-11357-113, 2011, on pre-dried samples in an N₂ atmosphere with heating and cooling rate of 20° C./min. Herein Tm has been calculated from the peak value of the highest melting peak in the second heating cycle.

The semi-crystalline semi-aromatic polyamide suitably has a melting enthalpy (ΔHm) of at least 20 J/g, preferably at least 30 J/g, and more preferably at least 40 J/g. Herein the melting enthalpy (ΔHm) is measured by the DSC method according to ISO-11357-1/3, 2011, on pre-dried samples in an N₂ atmosphere with heating and cooling rate of 20° C./min. Herein ΔHm has been calculated from the surface under the melting peak in the second heating cycle.

With a semi-aromatic polyamide is herein understood a polyamide comprising repeat units derived from aromatic monomers (i.e. monomers comprising an aromatic group or backbone) and aliphatic monomers (i.e. monomers comprising an aliphatic backbone). Herein the monomers comprising an aromatic backbone may be, for example, an aromatic dicarboxylic acid, or an aromatic diamine, or an arylalkyl diamine, or any combination thereof.

The semi-crystalline semi-aromatic polyamide used in the optical fiber cable element according to the invention comprises repeat units derived from monomers essentially consisting of dicarboxylic acid and diamine. Herein the dicarboxylic acid consists for at least 55 mole % of aromatic dicarboxylic acid, relative to the total molar amount of dicarboxylic acid.

The semi-crystalline semi-aromatic polyamide may comprise other repeat units derived from polyamide forming monomers other than dicarboxylic acid and diamine; for example monofunctional carboxylic acids, trifunctional carboxylic acids, monofunctional and trifunctional amines, cyclic lactams and α,ω-aminoacids, and combinations thereof. However, the molar amount of other monomers shall be kept limited to 0-5 mole %, preferably in the range of 0-2.5 mole %, more preferably in the range of 0-1 mole % relative to the total molar amount of monomers from which the repeat units in the semi-crystalline semi-aromatic polyamide are derived, i.e. relative to the total molar amount of diamine, dicarboxylic acid and other polyamide forming monomers.

In a preferred embodiment of the invention, the semi-crystalline semi-aromatic polyamide comprises repeat units derived from dicarboxylic acid and diamine, wherein the dicarboxylic acid consists for at least 65 mole %, preferably at least 75 mole % and more preferably for 90-100 mole % of aromatic dicarboxylic acid. The molar percentage (mole %) is relative to the total molar amount of dicarboxylic acid. Herein the dicarboxylic acid may comprise a minor amount of aliphatic dicarboxylic acid, up to and including 35 mole %, preferably at most 25 mole %, even more preferably at most 10 mole %. Most preferably, the aliphatic dicarboxylic acid is present, if at all, in an amount of 0-2.5 mole %, relative to the total molar amount of dicarboxylic acid.

The aromatic dicarboxylic acid is suitably selected from terephthalic acid, 4,4′-biphenyldicarboxylic acid and naphthalene dicarboxylic acid, or any mixture thereof, or a combination of one or more thereof with isophthalic acid. Herein the amount of isophthalic acid is kept sufficiently low to retain the semi-crystalline character of the semi-crystalline semi-aromatic polyamide. Suitably, the semi-crystalline semi-aromatic polyamide comprises at most 40 mole %, preferably at most 30 mole %, more preferably at most 20 mole % of isophthalic acid, relative to the total molar amount of dicarboxylic acid. Also, preferably, the dicarboxylic acid comprises terephthalic acid and/or naphthalene dicarboxylic acid in an amount of at least 50 mole %, more preferably at least 60 mole %, even more preferably at least 70 mole % and most preferably at least 80 mole %, relative to the total molar amount of dicarboxylic acid. The advantage thereof is that the resistance against environmental stress of the optical fiber cable construction and the buffer tube therein is better.

The diamine suitably comprises aliphatic diamine, and optionally aromatic diamine next to aliphatic diamine. The aliphatic diamine suitably comprises linear aliphatic diamine, and may optionally further comprise branched aliphatic diamine and/or cyclic aliphatic diamine. The amounts of aromatic diamine, linear aliphatic diamine, and branched and/or cyclic aliphatic diamine are chosen such that the semi-crystalline character of the semi-crystalline semi-aromatic polyamide is retained. Preferably, the diamine comprises at least 50 mole %, more preferably at least 60 mole %, and still more preferably at least 75 mole % of linear aliphatic diamine, relative to the total molar amount of diamine. The advantage thereof is that the mechanical integrity of the optical fiber cable construction and the buffer tube therein is better retained.

Examples of linear diamines are 1,2-ethylene diamine, 1,3-propylene diamine, 1,4-butanediamine, 1,5-pentamethylenediamine, 1,6-hexamethylenediamine, 1,7-heptamethylenediamine, 1,8-octamethylenediamine, 1,9-nonane diamine, 1,10-decanediamine, 1,11-undecanediamine, 1,12-dodecanediamine and 1,18-octadecanediamine. These diamines are linear aliphatic C2-C18 diamines.

Examples of branched aliphatic diamines are 2-methylpentamethylendiamine, 2,2,4-trimethylhexamethylene diamine, 2,4,4-trimethylhexamethylenediamine, and 2-methyl-1,8-octanediamine. Examples of cyclic aliphatic diamines are 1,4-diaminocyclohexane, 4,4′-methylene-bis(cyclohexylamine) (PAC), 3,3′-dimethyl-4,4′-diaminocyclohexylmethane (MAC); 3,3′,5,5′-tetramethyl-4,4′-diaminocyclohexylmethane; 2,2′,3,3′-tetramethyl-4,4′-diaminocyclohexylmethane; norbornanediamine; and isophoronediamine (IPD).

In a particular embodiment, wherein the dicarboxylic acid comprises at least 95 mole % of aromatic dicarboxylic acids, the dicarboxylic acid comprises at least 60 mole % of terephthalic acid, relative to the total molar amount of dicarboxylic acid, and the diamine comprises at least 50 mole % of linear aliphatic diamine, relative to the total molar amount of diamine and at most 10 mole % of other monomeric components (other than diamines and dicarboxylic acids), relative to the total of diamines, dicarboxylic acids, and others.

In a preferred embodiment thereof, the semi-crystalline semi-aromatic polyamide comprises 60-100 mole % of terephthalic acid, 0-40 mole % of isophthalic acid and 0-2.5 mole % of another dicarboxylic acid, relative to the total molar amount of dicarboxylic acid, and 60-100 mole % of a linear aliphatic C4-C6 diamine, 0-40 mole % of a of a linear aliphatic C7-C12 diamine and 0-10 mole % of another diamine, relative to the total molar amount of diamine.

In another preferred embodiment thereof, the semi-aromatic polyamide comprises 10-35 mole % of isophthalic acid and 65-90 mole % of terephthalic acid, relative to the total molar amount of dicarboxylic acid, 75 mole % of linear aliphatic diamine, relative to the total molar amount of diamine and at most 2.5 mole % of other monomeric components (other than diamines and dicarboxylic acids) relative to the total of diamines and dicarboxylic acids, and others. Advantages of this embodiment, with isophthalic acid present in the said amount in combination with the presence of terephthalic acid, are that the ductility and the resistance against environmental stress of the optical fiber cable construction and the buffer tube therein are better, while allowing for tuning the extrusion conditions and applying a lower extrusion temperature, resulting in a more stable extrusion process.

Examples of suitable polyamides are the homopolyamides based on terephthalic acid (T), for example PA-5T, PA-7T, PA-8T, PA-9T, PA-10T, PA-11T, PA-12T, and the homopolyamides based on naphthalene dicarboxylic acid, for example PA-8N, PA-9N, PA10 and PA-12N, and copolymers thereof. Other examples are the copolyamides represented by the expression PA-XT/YT, wherein T is terephthalic acid and X and Y are two or more diamines chosen from linear aliphatic C4-C6 diamines, or one or more diamines chosen from linear aliphatic C4-C6 diamines and one or more diamines chosen from linear C7-C18 diamines. Other suitable polyamides are copolyamides represented by the expression PA-XT/XI, wherein T is terephthalic acid and I is isophthalic acid and X represents one or more diamines comprising at least one diamine selected from linear C4-C12 diamines.

The semi-crystalline semi-aromatic polyamide in the buffer tube in the optical fiber cable element according to the invention suitably has a viscosity number (VN) of at least 80, preferably at least 85 and more preferably at least 90. The VN is herein measured in 96% sulphuric acid with a polymer concentration of 0.005 g/ml at 25° C. by the method according to ISO 307, fourth edition. The advantage of a higher VN is that the optical fiber cable construction comprising said optical fiber cable element has an even better resistance against environmental stress factors. The viscosity number may be as high as 200 or even higher, but preferably is at most 160. Above a VN of 200, the extrusion pressure becomes very high and crystallization rate very slow.

The tube in the optical fiber cable element can consist of the semi-crystalline semi-aromatic polyamide or be made of a polymer composition comprising the semi-crystalline semi-aromatic polyamide and at least one other component. Suitably, the composition comprises at least one component selected from lubricants, colorants, nucleating agents, flame retardants and stabilizers, and any other auxiliary additive that may be used in polymer compositions for optical fiber buffer tubes. Other components that may be present, though in limited amount, include other polymers, [for example impact modifiers], fibrous reinforcing agents and inorganic fillers.

Also suitably, the composition consists of at least 60 wt % of the semi-crystalline semi-aromatic polyamide, 0-35 wt. % of one or more other polymers, 0-40 wt. % of fibrous reinforcing agent (e.g. aramid fibers, carbon fibers, glass fibers, basalt fibers and other fibrous reinforcing agents) or inorganic filler (e.g. talcum, mica, kaolin, wollastonite, montmorillonite, aluminum hydroxide, magnesium hydroxide, silicon oxide, zinc oxide, aluminum oxide, barium sulfate, calcium carbonate, calcium sulfate, glass flakes, glass spheres, hollow glass spheres), or a combination thereof, and 0-20 wt. % of one or more other components.

Preferably, the composition consists of at least 75 wt % of the semi-crystalline semi-aromatic polyamide, 0-20 wt. % of one or more other polymers, 0-20 wt. % of fibrous reinforcing agent or inorganic filler, or a combination thereof, and 0-10 wt. % of one or more other components.

More preferably, the composition consists of at least 85 wt % of the semi-crystalline semi-aromatic polyamide, 0-10 wt. % of one or more other polymers, 0-10 wt. % of fibrous reinforcing agent or inorganic filler, or a combination thereof, and 0-10 wt. % of one or more other components.

Preferably, the one or more other components in the composition preferably comprise one or more components selected from of lubricants, colorants, nucleating agents, flame retardants and stabilizers.

The tube in the optical fiber cable element can be a loose tube, a tight tube or a semi-loose [also known as semi-tight or loose tight] tube. Preferably, the tube is a loose tube, with hollow space inside the tube being at least partly filled with a thixotropic gel. The advantage of the tube being a loose tube at least partly filled with a thixotropic gel, is that there are less forces exerted on the optical fibers and hence the signal integrity is superior. The thixotropic gel allows for fiber movement in the tube and blocks water to contact the optical fibers.

The optical fibers in the optical fiber cable element and optical fiber cable construction according to the invention suitably consists of glass fibers. Fibers made of other materials suitable for optical data transmission may be used as well. The number of optical fibers in the optical fiber cable element suitably is an integer from 1 to 12. The optical fibers may comprise a coating layer. Suitably, each of the optical fibers in the optical fiber cable element have a coating with a different color.

The buffer tube consisting of the semi-crystalline semi-aromatic polyamide or made of the composition as according to the invention allows for applying smaller dimensions. Suitably, the buffer tube has a wall thickness of at most 0.40 mm, preferably at most 0.30 mm, more preferably at most 0.20 mm. The wall thickness may well be in the range of 0.1-0.175 mm. The buffer tube suitably has an inner diameter of at most 1.75 mm, preferably at most 1.6 mm, more preferably at most 1.5 mm, and most preferably at most 1.4 mm. The buffer tube may have an outer diameter of about 2.2 mm and above, though preferably the outer diameter is at most 2.15 mm, more preferably at most 2.0 mm, even more preferably at most 1.75 mm, and most preferably at most 1.6 mm.

The optical fiber cable element according to the invention can be produced by a process, wherein the buffer tube is made by melt-extrusion of the semi-crystalline semi-aromatic polyamide, or by melt-extrusion of a composition comprising the semi-crystalline semi-aromatic polyamide and at least one other component, around one or more optical fibers. The optical fibers may optionally have been impregnated with a thixotropic gel. The impregnation suitable has been done prior to the melt-extrusion step.

The invention also relates to a process for producing an optical fiber cable element. Herein a semi-crystalline semi-aromatic polyamide or a polymer composition as defined above is extruded around one or more optical fibers. These optical fibers may optionally have been impregnated with a thixotropic gel. In this process the buffer tube is formed from the semi-crystalline semi-aromatic polyamide or from the composition comprising the semi-crystalline semi-aromatic polyamide. After being produced by extrusion, the optical fiber cable element is suitably wound on a spool. It can also be packed and sealed, preferably after being wound on a spool, which is favorable for problem-free further assembling into an optical fiber cable construction or the installation thereof in its final application environment.

The invention also relates to an optical fiber cable construction, comprising a jacket and one or more optical fiber cable elements enveloped by the jacket. In the optical fiber cable construction according to the invention, at least one of the optical elements is an optical element according to invention as described above. The optical fiber cable construction may further components. Such further components, optionally present, can be, for example, selected from one or more strength members, filling tubes, flooding gel, and/or tape. The strength members can consist of or comprise, for example, aramid fibers or fiber reinforced plastic. The filling tubes can be empty tubes made of polyethylene or polypropylene.

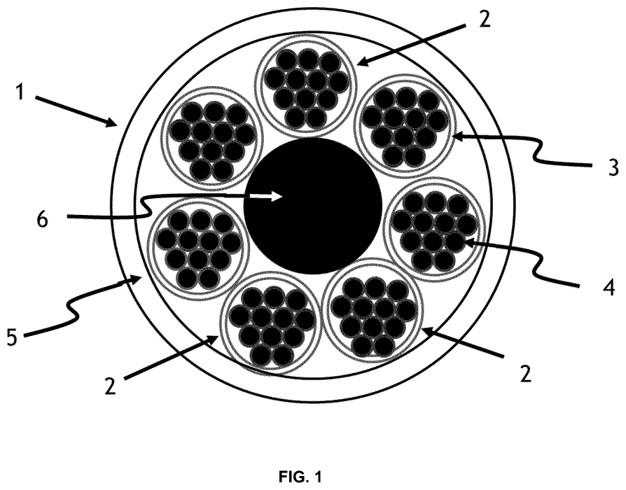

The invention is further explained with FIG. 1.

FIG. 1 shows a schematic cross section of an optical fiber cable construction (1) comprising multiple optical fiber cable elements (2). Herein the optical fiber cable elements (2), six in total, comprise each a buffer tube (3) and multiple optical fibers (4), 12 optical fibers per optical fiber cable element (2), and 72 optical fibers (4) in total in the optical fiber cable construction (1). The optical fiber cable construction (1) in FIG. 1 further comprises a jacket (5) and a strength member (6). In the construction as shown the strength member could also have been replaced by a filling tube (6′). The construction as shown represents the present invention when at least one of the buffer tubes (3) consists of the semi-crystalline semi-aromatic polyamide or is made of the composition as according to the invention.

The invention is further illustrated with the following examples and comparative experiments.

### Thermoplastic Polymer Materials Used in Various Examples (EX) and Comparative Experiments (CE).

| | |
|---|---|
| CE-A | PC: Markrolon ET3113, polycarbonate; ex Covestro. |
| CE-B | PBT: Celanex 2001, polybutylene terephthalate; ex Celanese. |
| CE-C | PA-46: Polyamide-46/6 (95/5), VN = 220; ex DSM. |
| CE-D | aPPA: Trogamid T5000, Polyamide-6-3T (6-3 = mixture of 2,2,4- |
| | trimethylhexamethylene diamine, 2,4,4-trimethylhexamethylene- |
| | diamine, amorphous semi-aromatic polyamide; ex Evonik. |
| EX-I | PPA-I: Polyamide-9T/XT ratio of 85/15 (X = 2-Me-octamethylene- |
| | diamine. VN = 110; semicrystalline semi-aromatic polyamide; ex |
| | Kuraray. |
| EX-II | PPA-II PA-4T/6T/6I (22/54/24) VN = 100; semicrystalline semi- |
| | aromatic polyamide; ex DSM. |

### Moulding of Test Samples

The thermoplastic polymer materials were injection moulded into a mould for test bars according to 527-1A, using an Enge1110 injection moulding machine equipped with a 25 mm screw. Temperature settings were chosen such that all samples were injected into the mould with a melt temperature of Tm+20° C. or in case of the Polycarbonate and Trogamid T5000 at 270° C. Mold temperature was 80° C. for all polymers except for the semi-crystalline PPA's for which the mold temperature was 130° C.

### Optical Fiber Element Extrusion:

The thermoplastic polymer materials were all dried prior to extrusion. Samples were extruded on at temperature settings chosen such that all samples were extruded with melt temperature of Tm+15° C. or in case of the Polycarbonate and Trogamid T5000 at 270° C. The thermoplastic polymer materials were extruded around and onto an aggregation of 12 optical fibers (200 μm (micrometer) overall diameter each: 100 μm diameter optical glass fiber with 50 μm thick coating layer surrounding the glass fibers) with a concomitant gel injection. After the coexctrusion of tube and gel the optical fiber element were quenched in a water bath of 60° C. for all polymers, cooled further in an additional water bath, after which adherent water was removed, and wound on a spool. The tubes on spools were packed in aluminium seal bags to prevent moisture pickup prior to further analysis. Tube out diameter was 1.35 mm and the inner diameter was 1.0 mm.

### Test Methods

### Mechanical Properties

Mechanical properties (tensile modulus [GPa], tensile strength [MPa], elongation at peak [%]) were measured in a tensile test according to ISO 527-1/2:2012 with a drawing speed of 50 mm/min at a temperature of 23° C. For the tests test bars conforming 527-type-1A or the extruded tubes with optical glass fibers removed were used.

### Shrinkage Test at 80° C.

For the shrinkage test, about 1 m of tube length was measured precisely at 23° C. (L1). The tube was then stored in an oven at 80° C. for 2 hours and when cooled back to 23° C. the precise length (L2) was measured again. The shrinkage at 80° C. is defined as the relative length change (%)=100%×(L1−L2)/L1.

### Solvent Exposure Test

A 10 cm long section of the tubes was submersed into isopropanol for 15 minutes. After immersion, the samples were taken out and evaluated to see if they had been affected by the solvent exposure. Next, the samples were rubbed for 10 times with a cotton swab soaked in isopropanol. The samples were examined again for any effects of the solvent rub.

### Temperature Cycling Test

Temperature Cycling was performed on a section of the optical fiber elements with a length of about 3 m of which 1.5 m was wound up on a spool with a diameter of 10 cm. The section of the optical fiber elements thus wound on the real were provided with a connector. Upon installation of the optical fiber element to the connector, the gel was removed from the optical fiber element by rubbing with isopropanol. The connector set up was placed as a whole inside a thermal chamber and connected to optical measuring equipment located outside the chamber. The sample was subjected to repetitive temperature cycles. The temperature was cycled between −20° C. and 80° C. with 15 minutes holding time at each end temperature and the rate of temperature change=2° C./min. This was repeated for 100 cycles, amounting to a total test time of 13000 minutes˜9 days. On completion of the test, the temperature was returned to 23° C. and the connector set sample removed from the chamber.

The optical attenuation was measured at the start (initial measurements), through the test and at the end (final measurements). Thus, the changes in optical transmittance was monitored throughout the test. A visual inspection was carried out to identify any damage or other anomalies.

The following information was reported for each measurement:
Optical transmittance during the test. Pass when optical loss was <1 dB at 1310 nm during the whole test when compared to initial value. Fail when optical loss was >1 dB at 1310 nm during the whole test when compared to initial value.
Result of external visual inspection. Pass when no visible changes were noted. Fail when the buffer tube was damaged.

TABLE 1

| | CE-A | CE-B | CE-C | CE-D | EX-I | EX-II |
|---|---|---|---|---|---|---|
| Polymer | PC | PBT | PA-46 | aPPA | PPA-I | PPA-II |
| Tg (° C.) | 147 | 66 | 75 | 153 | 125 | 138 |
| Tm (° C.) | — | 225 | 295 | — | 308 | 309 |
| Polymer composition (wt. %) | 100 | 100 | 100 | 100 | 100 | 100 |
| Tensile strength at yield (ISO 527-1) | 65 | 60 | 100 | 90 | 85 | 95 |
| Tensile modulus (ISO 527-1) | 2.35 | 2.5 | 3.3 | 2.8 | 2.5 | 3.3 |
| Mechanical strength at peak at low | 59 | 55 | 95 | 85 | 75 | 90 |
| dimensions (tube Ø 1.5 μm) (MPa) | | | | | | |
| Stiffness at low dimensions 0.2-0.4% | 1.9 | 1.8 | 2.8 | 2.4 | 2.2 | 2.4 |
| elongation (tube Ø 1.5 μm) (GPa) | | | | | | |
| Elongation at break at low dimension | >50 | >50 | >50 | >50 | >50 | >50 |
| (tube Ø 1.5 μm) (%) | | | | | | |
| Thermal cycling tests + qualitative | Fail, loss > | Fail, loss > | Fail, loss > | Fail, loss > | Pass | Pass |
| performance in transmittance test | 1 dB bad | 1 dB | 1 dB | 1 dB | good | |
| Thermal cycling tests including | Fail. Tube | Fail. Tube | Pass. | Fail. Tube | Pass | Pass |
| solvent exposure; visual inspection | is visibly | visibly cracked | Tube is | is visibly | No visible | No visible |
| of tubes near connection section | cracked. | and kinked. | kinked. | cracked. | change | change |

Optical fiber element having a buffer tube made from semi crystalline semi-aromatic polyamides EX-I and EX-II showed a low attenuation (i.e. a low transmission loss) after the thermal cycling test, whereas comparative examples (CE-A to CE-D) including PBT, PC, aliphatic polyamide-46 and amorphous polyamide-6-3T showed high attenuation after the thermal cycling test. Also the visible inspection after the thermal cycling test showed that optical fiber elements with buffer tubes made from semi crystalline semi-aromatic polyamides EX-I and EX-II had an intact buffer tube, whereas the comparative examples CE-A, CE-B and CE-D showed cracks near the connectors.

Optical fiber element with buffer tubes made from semi crystalline semi-aromatic polyamides EX-I, EX-II, CE-A, CE-B and CE-D have low shrinkage values, whereas aliphatic polyamide-46 has an undesired high shrinkage level.

Optical fiber element with buffer tubes made from semi crystalline semi-aromatic polyamides EX-I and EX-II and CE-C had an intact buffer tube after the solvent resistance test, whereas the comparative examples CE-A, CE-B and CE-D were cracked.

The optical fiber elements made according to the invention have high strength and stiffness, which gives cable construct designer flexibility in the cable construct design and for instance allow for making the wall thickness thinner, the whole cable construct can be thinner and the use of a less strong strength member. Next to that, optical fiber elements according to the invention can better withstand the typical installation procedures and environmental stresses have a better dimensional stability as indicated by the thermal cycling test.

1. Optical fiber cable element comprising a tube, referred to as buffer tube, and one or more optical fibers inside the hollow space of the buffer tube, wherein the buffer tube is made of a semi-crystalline semi-aromatic polyamide or of a composition comprising the semi-crystalline semi-aromatic polyamide and at least one other component, and wherein the semi-crystalline semi-aromatic polyamide has a glass transition temperature (Tg) of at least 100° C., and consists of repeat units derived from diamine, dicarboxylic acid and 0-5 mole % other polyamide forming monomers, relative to the total molar amount of diamine, dicarboxylic acid and other polyamide forming monomers, wherein at least 55 mole % of the dicarboxylic acid is aromatic dicarboxylic acid.

2. Optical fiber cable element according to claim 1, wherein the semi-crystalline semi-aromatic polyamide has a melting temperature (Tm) in the range of 240-340° C.

3. Optical fiber cable element according to claim 1, wherein the semi-crystalline semi-aromatic polyamide has a glass transition temperature (Tg) of at least 110° C.

4. Optical fiber cable element according to claim 1, wherein the semi-crystalline semi-aromatic polyamide has a viscosity number (VN) of at least 80.

5. Optical fiber cable element according to claim 1, wherein at least 95 mole % of the dicarboxylic acid is aromatic dicarboxylic acid.

6. Optical fiber cable element according to claim 1, wherein at least 60 mole % of the dicarboxylic acid is terephthalic acid, and at least 50 mole % of the diamine is a linear aliphatic diamine.

7. Optical fiber cable element according to claim 1, wherein the buffer tube is made of a polymer composition comprising the semi-crystalline semi-aromatic polyamide and at least one component selected from lubricants, colorants, nucleating agents, flame retardants and stabilizers.

8. Optical fiber cable element according to claim 7, wherein the polymer composition consists of at least 60 wt % of the semi-crystalline semi-aromatic polyamide; 0-35 wt. % one or more other polymers; 0-40 wt. % of fibrous reinforcing agent or inorganic filler, or a combination thereof; and 0-20 wt. % of one or more other components.

9. Optical fiber cable element according to claim 1, wherein the buffer tube is a loose buffer tube, and wherein the hollow space of the buffer tube is at least partly filled with a thixotropic gel.

10. Optical fiber cable element according to claim 1, wherein the buffer tube has a wall thickness of at most 0.40 mm, an inner diameter of at most 1.75 mm and an outer diameter of at most 2.15 mm.

11. Optical fiber cable element according to claim 1, wherein the buffer tube is made by melt-extrusion of the semi-crystalline semi-aromatic polyamide, or by melt-extrusion of a composition comprising the semi-crystalline semi-aromatic polyamide and at least one other component, around one or more optical fibers.

12. Process for producing an optical fiber cable element comprising a buffer tube and one or more optical fibers enveloped by the buffer tube, wherein a semi-crystalline semi-aromatic polyamide as defined in claim 1, or a polymer composition comprising a semi-crystalline semi-aromatic polyamide, is extruded around one or more optical fibers, thereby forming the buffer tube from the semi-crystalline semi-aromatic polyamide or from the composition comprising the semi-crystalline semi-aromatic polyamide.

13. Process according to claim 12, wherein the optical fiber cable element is an optical fiber cable element.

14. Process according to claim 12, wherein the optical fiber cable element is wound on a spool, and/or packed and sealed.

15. Optical fiber cable construction, comprising a jacket and one or more optical fiber cable elements enveloped by the jacket, wherein at least one optical fiber cable element is an optical fiber cable element as defined in claim 1.
